(19) United States
(12) Patent Application Publication
(10) Pub. No.: US 2002/0191130 A1
(43) Pub. Date: Dec. 19, 2002

(54) Color display utilizing combinations of four colors

(76) Inventors: Wei-Chen Liang, Hsinchu (TW); Pin Chang, Hsinchu (TW); Heng-Chung Wu, Hsinchu-Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/883,291

(22) Filed: Jun. 19, 2001

(51) Int. Cl. G02F 1/1335

(52) U.S. Cl. 349/108

(57) ABSTRACT

The present invention proposes a color display utilizing combinations of four colors, wherein full-color images are obtained by controlling gray-scale contrast of a plurality of pixels each having four colors. The four colors are two primary colors and two contrastive colors complementary to them, e.g., the red and its complementary color—cyan and the green and its complementary color—magenta. The present invention can enhance the color fullness and the delicacy of images without increasing the cost and changing the design of structure.

### FIELD OF THE INVENTION

The present invention relates to a display and, more particularly, to a color display capable of displaying full color.

### BACKGROUND OF THE INVENTION

Displays are inevitable equipments of the present information society. They play the roles as output devices for showing pictures and texts. Along with the development of information products toward compactness, flat panel displays become the mainstream of electronic application products gradually. In general flat panel displays, no matter what kind of displaying means is adopted, color images are obtained using various kinds of variations and combinations of the three primary colors of red, green, and blue.

With a liquid crystal display (LCD) as an example, each pixel on a liquid crystal panel is divided into three sub-pixels, which show the three primary colors of red, green and blue through a color filter, respectively. Full-color displaying is achieved through mixing different ratios of the three primary colors. Although this kind of using the three primary colors can achieve the object of full-color displaying, the colors that can be displayed are limited in the triangle enclosed by the three primary colors. For those customers having higher requirement of colors, the colors that can be displayed are not satisfactory, and quality of color images is rougher and unnatural. The present invention aims to propose a color display utilizing combinations of four to enhance the quality of color images.

### SUMMARY OF THE INVENTION

The primary object of the present invention is to propose a color display utilizing combinations of four colors to display color images so as to enhance the color fullness and to have good quality of color images.

Another object of the present invention is to propose a color utilizing combinations of four colors, wherein the count of ICs used in a color driving module thereof is comparable to that used in a display composed of the three primary colors. Therefore, delicacy of colors can be enhanced without increasing the cost.

According to the present invention, the color displaying way of a color display is accomplished by controlling variations and combinations of brightness and gray-scale contrast of a plurality of pixels each having four colors to achieve the object of full-color displaying. The four colors are a first primary color and its complementary color, and a second primary color and its complementary color, respectively.

The various objects and advantages of the present invention will be more readily understood from the following detailed description when read in conjunction with the appended drawings, in which:

### BRIEF DESCRIPTION OF THE DRAWINGS

FIG. 1 is a structure diagram of a liquid crystal display;

FIG. 2 is a diagram of a color driving module according to an embodiment of the present invention;

FIG. 3 is a diagram of a color driving module according to another embodiment of the present invention; and

FIG. 4 is a structure diagram of an organic light emitting diode.

### DETAILED DESCRIPTION OF THE PREFERRED EMBODIMENTS

The present invention is characterized in that color images are obtained using variations and combinations of four colors. The four colors are selected from two different primary colors and two contrastive colors complementary to them. The characteristics of the present invention will be illustrated by describing an LCD and an OLED below.

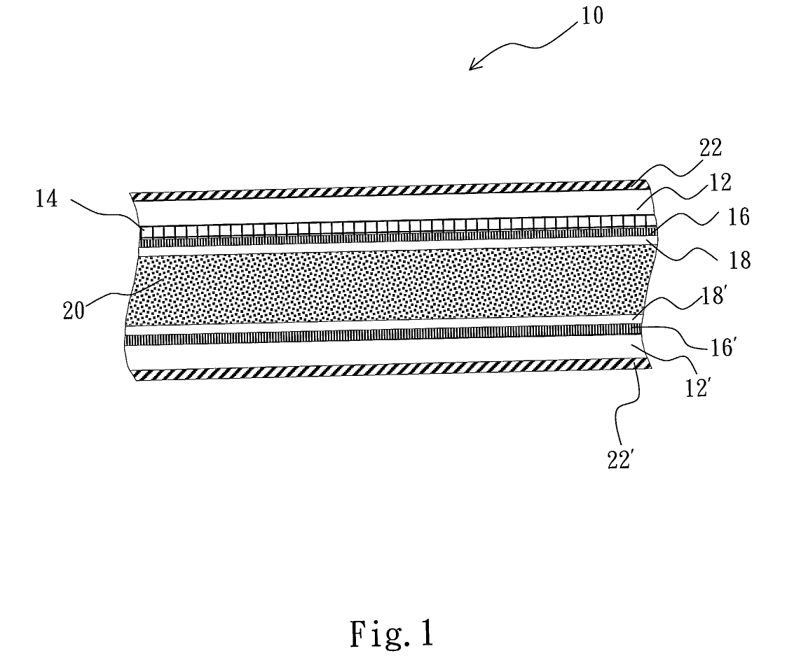

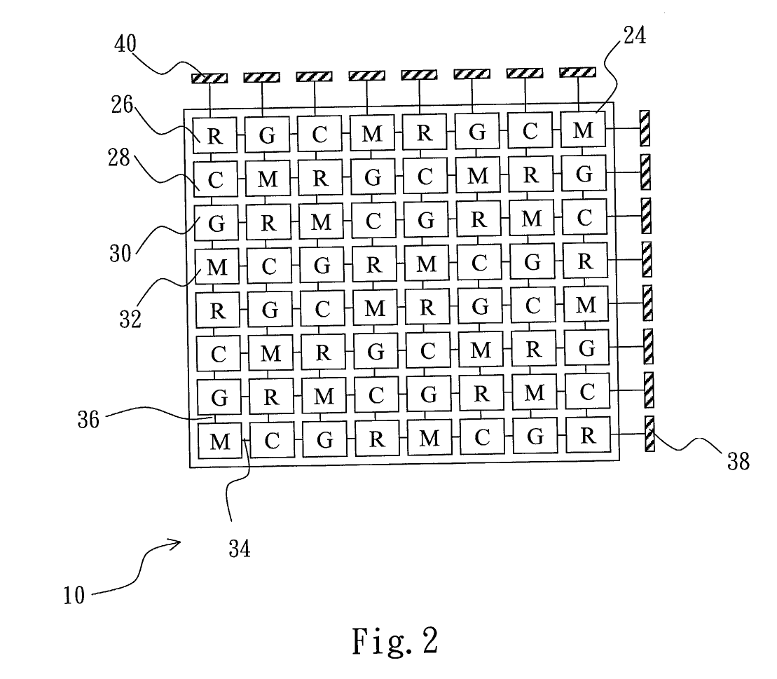

As shown in FIG. 1, an LCD 10 comprises two transparent substrates 12 and 12′ with a color filter 14, a transparent electrode plate 16, an orientation film 18, a liquid crystal layer 20, an orientation film 18′, and a transparent electrode plate 16′ sandwiched in between from top to bottom in this order. Liquid crystal molecules will rotate and arrange according the direction specified by the orientation films 18 and 18′. Two polarizers 22 and 22′ cover the outer surfaces of the two transparent substrates 12 and 12′, respectively. A plurality of sub-pixels 24 selected from the four colors are uniformly arranged on the color filter 14. The four colors are a first primary color 26 and its complementary color 28, and a second primary color 30 and its complementary color 32, respectively. The arrangement of the sub-pixels 24 of different colors is shown in FIG. 2. The colors of the sub-pixels 24 are selected from the four colors of red (R), cyan (C), green (G), and magenta (M). Each column and each row of the sub-pixels 24 show uniform and alternate arrangement of the four colors of R, C, G, and M. The above primary colors and their complementary colors can be selected from any two groups of the red and its complementary color—cyan, the blue and its complementary color—yellow, and the green and its complementary color—magenta.

The arrangement of the four colors of each column and each row of the sub-pixels 24 of the color filter 14 is uniform so that good white balance can be achieved. Therefore, the background of a display can be conditioned to a very good white color. Moreover, the range of colors that can be conditioned according to different ratios of the above four colors are a quadrangle with an area much larger than that of the triangle enclosed by the three primary colors. Higher color fullness can be obtained by the colors displayed in the present invention than those composed of the three primary colors. Therefore, a color display of the present invention can show vivid, natural, beautiful, and colorful images.

A signal scan line 34 and a data transmission line 36 are provided for each row and each column of the sub-pixels 24. The signal scan lines 34 and the data transmission lines 36 are driven by a set of signal scan driving parts 38 and a set of data transmission driving parts 40, respectively. The data transmission lines 36 and the signal scan lines 34 are modules composed of indium tin oxide (ITO) at the upper and lower layers, and are uniformly arranged on the transparent electrode plates 16 and 16′, respectively. The design of the color driving module is similar to that of a driving module that generates color images using the three primary colors. Moreover, the counts of semiconductor driving parts used are commensurate. Therefore, the present invention can enhance the color fullness and improve the quality of image without increasing the cost. The signal scan driving part 38 and the data transmission driving part 40 can be separate active IC devices.

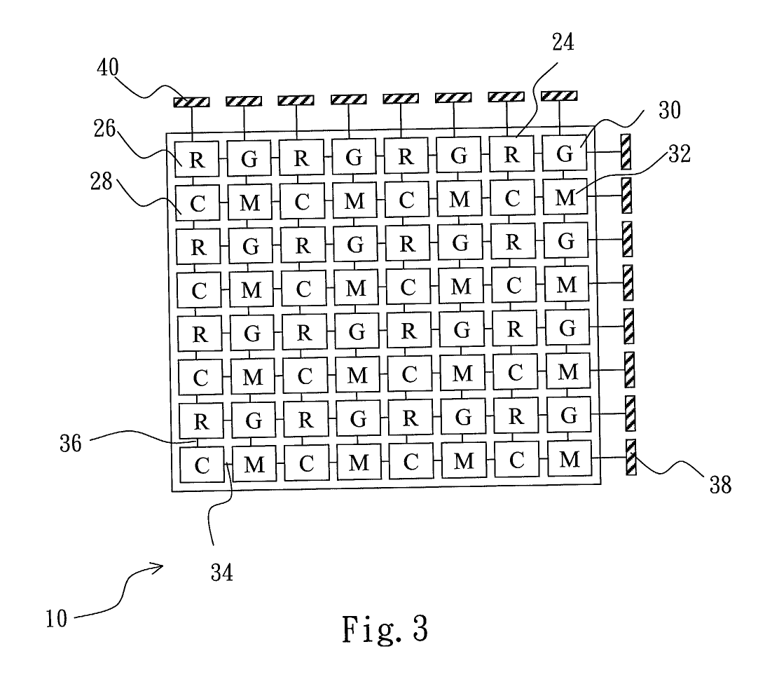

Furthermore, the arrangement of the sub-pixels 24 having different colors can be the way shown in FIG. 3. Each column of the sub-pixels 24 is formed by uniformly arranging the first primary color 26 and its complementary color 28, and the adjacent columns of the sub pixels 24 are formed by uniformly arranging the second primary color 30 and its complementary color 32. Although this kind of arrangement will easily let the background of a display have a color, higher color fullness can be obtained with the colors conditioned by the four colors.

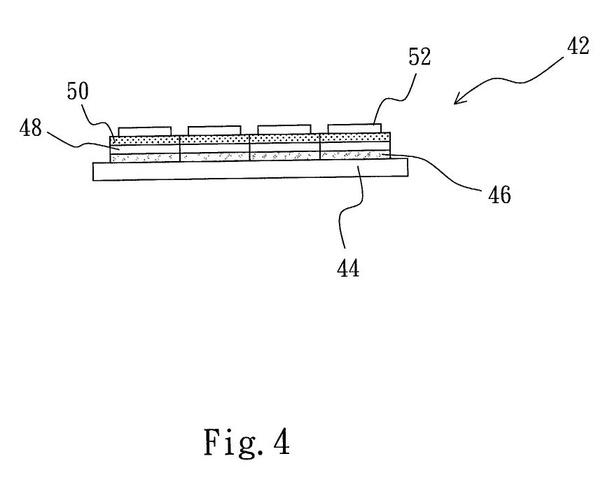

As shown in FIG. 4, an OLED 42 comprises a glass substrate 44 with an ITO electrode layer 46, a protection film 48, a light-emitting layer 50, and a metal electrode layer 52 disposed thereon in this order. Four kinds of light-emitting materials of organic molecules are uniformly coated on the light-emitting layer 50. The four kinds of light-emitting materials can emit out two kinds of primary colors and their complementary colors. When electrified, electrons of outer layers of organic molecules will be excited to a higher energy level and then drop to the lower energy level, emitting out photons having an energy of this difference of energy levels. Therefore, the pixels can show colors. The arrangement and connection of the light-emitting materials are the same as those of the sub-pixels in the above LCD and thus will not be further described.

To sum up, without increasing the cost, a color display utilizing combinations of four colors of the present invention can obtain vivid and natural full-color images having higher color fullness and no distortion, thereby satisfying those customers having higher requirement of colors.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A color display utilizing combinations of four colors, wherein color images are obtained by controlling gray-scale contrast of a plurality of pixels each having four colors, said four colors being two primary colors and two contrastive colors complementary to them.

2. The color display utilizing combinations of four colors as claimed in claim 1, wherein said primary colors are red and green, and said two contrastive colors complementary to them are cyan and magenta.

3. The color display utilizing combinations of four colors as claimed in claim 1, wherein said primary colors are red and blue, and said two contrastive colors complementary to them are cyan and yellow.

4. The color display utilizing combinations of four colors as claimed in claim 1, wherein said primary colors are green and blue, and said two contrastive colors complementary to them are magenta and yellow.

5. The color display utilizing combinations of four colors as claimed in claim 1, wherein each column and each row of said sub-pixels are formed by orderly arrangement of any combination of said four colors.

6. The color display utilizing combinations of four colors as claimed in claim 1, wherein each column and each row of said sub-pixels can be driven and controlled using separate active integrated circuit devices.
